(19) United States
(12) Patent Application Publication
(10) Pub. No.: US 2011/0117933 A1
(43) Pub. Date: May 19, 2011

(54) Mobile Terminals, Methods and Computer Program Products for Determining a Location Proximate a Vehicle

(76) Inventor: Henrik Bo Andersson, Lund (SE)

(21) Appl. No.: 12/619,978

(22) Filed: Nov. 17, 2009

(51) Int. Cl. H04W 64/00

(52) U.S. Cl. 455/456.2

(57) ABSTRACT

Mobile terminals, methods and computer program products for locating a position of a vehicle on a mobile terminal include identifying a triggering event received by the mobile terminal via a communication link between the mobile terminal and an external device. A geographic location is determined that approximates the position of the vehicle responsive to the triggering event. The information regarding the geographic location that approximates the position of the vehicle is subsequently provided.

### FIELD OF THE INVENTION

The present invention relates to mobile terminals, methods and computer program products for determining a location proximate a vehicle, and more particularly, to determining a location of a vehicle responsive to a triggering event.

### BACKGROUND

Navigation systems using global positioning system (GPS) units are known in the art and may be used to determine a current location of a GPS unit. GPS units may be useful for mapping information to provide directions to the user between the user's current location and a desired destination.

### SUMMARY OF EMBODIMENTS OF THE INVENTION

According to some embodiments of the present invention, methods for locating a position of a vehicle on a mobile terminal include identifying a triggering event associated with a communication link between the mobile terminal and an external device. A geographic location is determined that approximates the position of the vehicle responsive to the triggering event. The information regarding the geographic location that approximates the position of the vehicle is subsequently displayed on the mobile terminal.

In some embodiments, the external device comprises a handsfree communication system, and the triggering event includes determining that a disconnection from the handsfree communication system has occurred. The disconnection from the handsfree communication link may include a disconnection from a short radio wave handsfree communication link. The handsfree communication system may be mounted on the vehicle. The external device may include a handsfree communication system having a wired connection to the mobile terminal, and the triggering event may include a disconnection from a wired connection between the mobile terminal and the handsfree communication system.

In some embodiments, location information is determined by receiving location information from a global positioning unit connected to the vehicle. In some embodiments, location information is received from a global positioning system (GPS) unit on the mobile phone.

In some embodiments, the triggering event includes detecting a communication from a remote keyless device that is configured to operate a component of the vehicle. The remote keyless device may be configured to communicate the triggering event to the mobile terminal when the remote keyless device locks the vehicle and/or terminates an operation of the vehicle.

In some embodiments, the geographic location is determined responsive to detecting that the mobile terminal has ceased traveling above a threshold velocity for at least a threshold time, wherein the velocity is determined responsive to global positioning system signals.

In some embodiments, the mobile terminal comprises an accelerometer, and the geographic location of the vehicle is determined by determining the location of the vehicle responsive to detecting a repetitive acceleration pattern that indicates that the mobile terminal has transitioned from a vehicle to a person who is walking.

According to some embodiments of the present invention, a mobile terminal for locating a position of a vehicle is provided. The mobile terminal includes a triggering event module configured to identify a triggering event associated with a communication link between the mobile terminal and an external device and to determine a geographic location that approximates the position of the vehicle responsive to the triggering event. A navigation module is configured to subsequently display on the mobile terminal information regarding the geographic location that approximates the position of the vehicle.

In some embodiments, the external device comprises a handsfree communication system, and the triggering event includes determining that a disconnection from the handsfree communication system has occurred. The disconnection from the handsfree communication link may include a disconnection from a short radio wave handsfree communication link. The handsfree communication system may be mounted on the vehicle.

In some embodiments, the external device includes a handsfree communication system having a wired connection to the mobile terminal, and the triggering event comprises a disconnection from a wired connection between the mobile terminal and the handsfree communication system.

In some embodiments, a location module is configured to receive location information from a global positioning system (UPS) unit. In some embodiments, a location module is configured to receive location information from a global positioning system (GPS) unit on the mobile terminal and/or on the vehicle.

In some embodiments, the triggering event includes detecting a communication from a remote keyless device that is configured to operate a component of the vehicle. The remote keyless device may be configured to communicate the triggering event to the mobile terminal when the remote keyless device locks the vehicle and/or terminates operations of the vehicle.

In some embodiments, the triggering event module is configured to determine the geographic location responsive to detecting that the mobile terminal has ceased traveling above a threshold velocity for at least a threshold time, and the velocity is determined responsive to global positioning system signals.

In some embodiments, the mobile terminal includes an accelerometer, and the triggering event module is configured to determine the location of the vehicle responsive to detecting a repetitive acceleration pattern that indicates that the mobile terminal has transitioned from a vehicle to a person who is walking.

### BRIEF DESCRIPTION OF THE DRAWINGS

The accompanying drawings, which are incorporated in and constitute a part of the specification, illustrate embodiments of the invention and, together with the description, serve to explain principles of the invention.

FIG. 1 is a flowchart illustrating operations for operating a mobile terminal to locate a vehicle according to some embodiments of the present invention.

FIG. 2 is a schematic diagram of a network environment illustrating a mobile terminal according to some embodiments of the present invention.

FIG. 3 is a block diagram illustrating a mobile terminal according to embodiments of the present invention.

FIG. 4 is a block diagram illustrating a hardware/software architecture illustrating computer program products, systems and methods according to embodiments of the present invention.

### DETAILED DESCRIPTION OF EMBODIMENTS OF THE INVENTION

The present invention now will be described hereinafter with reference to the accompanying drawings and examples, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art.

Like numbers refer to like elements throughout. In the figures, the thickness of certain lines, layers, components, elements or features may be exaggerated for clarity.

The terminology used herein is for the purpose of describing particular embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof. As used herein, the term “and/or” includes any and all combinations of one or more of the associated listed items. As used herein, phrases such as “between X and Y” and “between about X and Y” should be interpreted to include X and Y. As used herein, phrases such as “between about X and Y” mean “between about X and about Y.” As used herein, phrases such as “from about X to Y” mean “from about X to about Y.”

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the specification and relevant art and should not be interpreted in an idealized or overly formal sense unless expressly so defined herein. Well-known functions or constructions may not be described in detail for brevity and/or clarity.

It will be understood that, although the terms “first,” “second,” etc. may be used herein to describe various elements, these elements should not be limited by these terms. These terms are only used to distinguish one element from another. Thus, a “first” element discussed below could also be termed a “second” element without departing from the teachings of the present invention. The sequence of operations (or steps) is not limited to the order presented in the claims or figures unless specifically indicated otherwise.

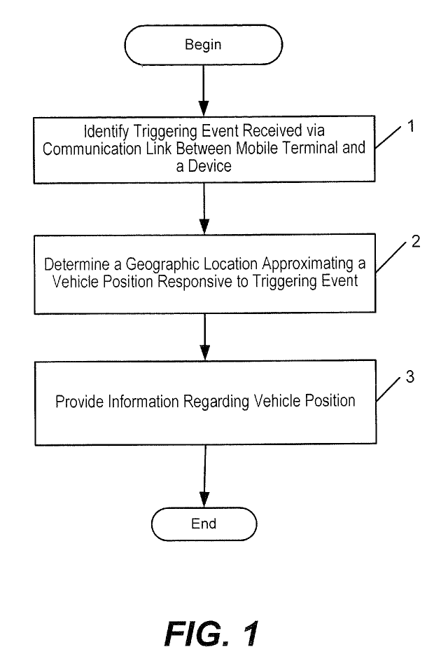

According to some embodiments of the invention, a mobile terminal may determine a location of a vehicle responsive to a triggering event. The location information may be subsequently provided to the user to assist the user in locating the vehicle. As illustrated in FIG. 1, a triggering event may be received via a communication link between a mobile terminal and an external device (Block 1). For example, the triggering event may be an event that generally indicates a time when a vehicle has been parked or turned off such that the location of the vehicle may be automatically recorded for future use. Examples of triggering events include detecting a disconnection from a handsfree communication link that may occur when operation of the vehicle is terminated or detecting a signal from another external device, such as a keyless remote, that may indicate when operation of the vehicle is terminated. The mobile terminal determines a geographic location approximating the vehicle position that is responsive to the triggering event (Block 2). For example, the current location of the mobile terminal may be determined (e.g., using a global positioning system (GPS) on the mobile terminal) responsive to the triggering event to approximate the location of the vehicle, or geographic location information can be received from a GPS in the vehicle. In some embodiments, geographic location information can be received by the mobile terminal from a GPS in the vehicle shortly before the vehicle is turned off. The information regarding the vehicle position may be provided to a user (Block 3), for example, to assist the user in locating the vehicle at a later time.

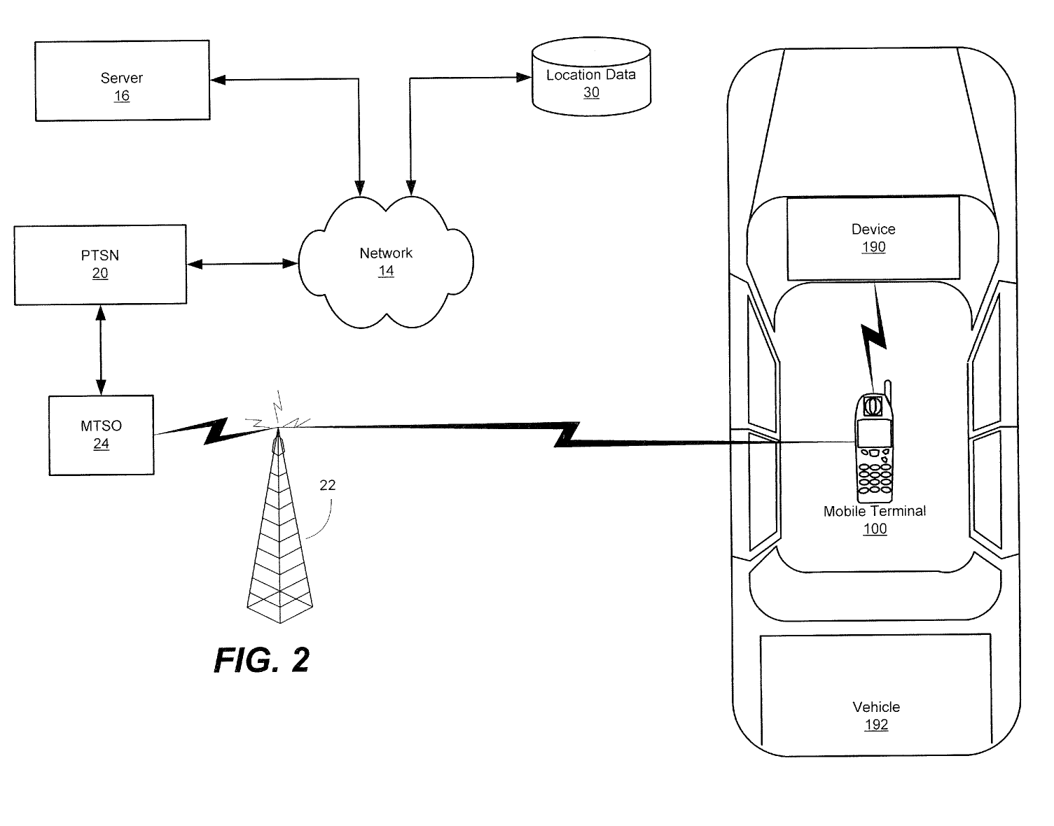

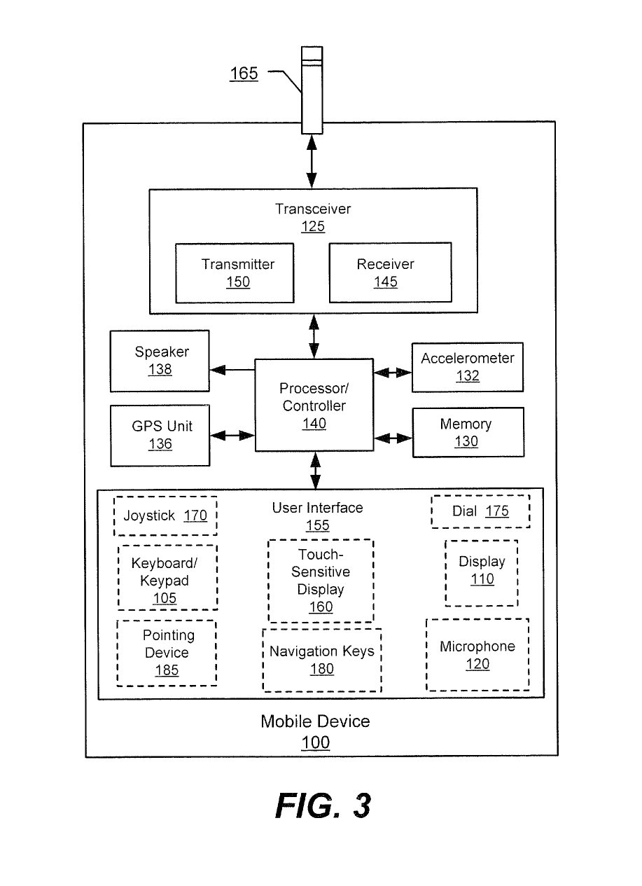

FIG. 2 illustrates a network environment in which embodiments of the present invention may be utilized. As will be appreciated by those of skill in the art, however, the operations of embodiments of the present invention may be carried out on a processing system that communicates with one or more other devices and/or terminals with or without access to a network. As seen in FIG. 2, the mobile terminal 100 may communicate over a network 14. The mobile terminal 100 may be a radiotelephone or other handheld device, such as a personal wirelessly enabled digital assistants (personal data assistants (PDAs), such as Palm Pilot™ or a Pocket PC™, smartphones, pagers, wireless messaging devices (such as a Blackberry™, or iPhone™ wireless handheld device), wireless enabled laptop computers, global positioning system (GPS) units configured to provide directions, and other mobile communications devices and/or combinations thereof. The mobile terminal 100 may include a global positioning system (GPS) unit, such as the GPS unit 136 shown in FIG. 3. As illustrated in FIG. 2, the mobile terminal 100 may be in communication with an external device 190 mounted on a vehicle 192. Although the external device 190 is illustrated in FIG. 2 as being integrated with the vehicle 192, it should be understood that the external device 190 may be provided as a separate unit from the vehicle 192. Although the vehicle 192 illustrated in FIG. 2 is an automobile, it should be understood that any vehicle could be used, including but not limited to motorcycles, scooters, and boats. Moreover, although embodiments of the present invention are described herein with respect to global positioning system (GPS) units, it should be understood that any location device could be used, including European Geostationary Navigation Overlay Service (EGNOS).

The mobile terminal 100 may communicate through one or more mobile telecommunications switching offices (MTSOs) 24 via base stations 22. The MTSO 24 may provide communications with a public telecommunications switching network (PTSN) 20, which can, in turn, can provide communications with the network 14. The mobile terminal 100 may be connected to the network 14 using various techniques, including those known to those of skill in the art, such as using a Wireless Fidelity (Wi-Fi) or Worldwide Interoperability for Microwave Access (Wi-Max) connection. As is further illustrated in FIG. 2, the server 16 can be in communication with data sources such as location data 30 and/or the PTSN 20. The data 30 can be computer servers, processing systems, and/or other network elements that can send data to the mobile terminal 100 over the network 14.

It should be understood that the mobile terminal 100 can communicate with the network 14 directly or indirectly, such as via other networks, including wireless networks. Moreover, mobile terminals be provided that combine various functionalities. For example, the mobile terminal 100 may be configured to connect to the network 14 through the base station 22, the MTSO 24, the PTSN 20, a modem, a wireless network and/or a combination thereof.

The mobile terminal 100 may utilize applications to communicate over the base station (s) 22, the MTSO 24, and/or network 14 to another mobile terminal, stationary device, or data processing system, such as a server 16. The network 14 may be an intranet or the Internet or other networks known to those of skill in the art.

As illustrated in FIG. 2, the mobile terminal 100 may be in communication with the external device 190, which is optionally integrated as part of the vehicle 192. The external device 190 is configured to communicate a triggering event to the mobile terminal 100. When the mobile terminal 100 receives the triggering event from the external device 190, the mobile terminal 100 determines and/or stores a geographic location that approximates the position of the vehicle 192 responsive to the triggering event. The mobile terminal 100 may subsequently provide information regarding the geographic location that approximates the location of the vehicle 192 to a user, for example, to assist the user in locating the vehicle.

In some embodiments, the triggering event may relate to an indication that the operations of the vehicle 192 are terminated. For example, the external device 190 may be a handsfree communication system that is configured to terminate communications with the mobile terminal 100 when the vehicle 192 is turned off. The termination of communications between the external device 190 and the mobile terminal 100 may provide a triggering event such that a geographic location associated with the vehicle 190 is recorded responsive to the disconnection of the external device 190. Some examples of triggering events may relate to indications that the user (who is typically carrying the mobile terminal 100) has stopped traveling in a car. For example, the geographic location may be determined responsive to detecting that the mobile terminal 100 has ceased traveling above a threshold velocity for at least a threshold time, and the velocity may be determined responsive to global positioning system signals. In some embodiments, the mobile terminal 100 includes an accelerometer, and the geographic location of the vehicle 192 is determined by determining the location of the vehicle 192 responsive to detecting a repetitive acceleration pattern that indicates that the mobile terminal 100 has transitioned from a vehicle to a person who is walking using acceleration patterns detected by the accelerometer.

In some embodiments, the external device 190 is a handsfree communication system that is mounted on the vehicle 192. For example, speakers, microphones and other components can be mounted on the vehicle 192 to provide handsfree communication with the base station 22 via the mobile terminal 100. However, it should be understood that any handsfree communication system may be used, including mobile handsfree devices such as Bluetooth® headsets or other mobile handsfree devices.

In addition, it should be further understood that the external device 190 may be any suitable external device configured to communicate with the mobile terminal 100 according to embodiments of the present invention. In some embodiments, the external device 190 may be a radiofrequency identification (RFID) unit, a keyless remote, a keyless remote starter for operating the vehicle or any external device having communications capable of sending a triggering event to the mobile terminal. The external device 190 may be configured to communicate a triggering event automatically when operations of the vehicle are terminated and/or a user exits the vehicle. As discussed above, the external device 190 may be a handsfree communication system that automatically disconnects from the mobile terminal 100 when the operations of the vehicle 192 are terminated. The disconnection from the handsfree communication system may be detected by the mobile terminal 100 as a triggering event that triggers recording of a geographic location. In some embodiments, the external device 190 may be a keyless remote for operating the vehicle functionality (e.g., operating door locks and/or operating the vehicle's engine) that is provided as a separate device from the vehicle 192, and the keyless remote may provide a triggering event signal, for example, when the vehicle 192 is locked or operations terminated. The triggering event signal may be a signal communicated via various communications protocols, including short distance communications protocols, including but not limited to Bluetooth®, RFID, and/or WLAN (e.g., 802.11a, 802.11b, 802.11e, 802.11g, 802.11i and/or 802.11n).

FIG. 3 is a block diagram illustrating a mobile terminal 100 in accordance with some embodiments of the present invention. As shown in FIG. 3, an exemplary mobile terminal 100 includes a transceiver 125, memory 130, an accelerometer 132, a GPS unit 136, a speaker 138, a controller or processor 140, and a user interface 155. The transceiver 125 typically includes a transmitter circuit 150 and a receiver circuit 145 which cooperate to transmit and receive radio frequency signals to and from base station transceivers via an antenna 165. The processor 140 may be configured to communication over the transceiver 125 using one or more communication protocols. For example, cellular communication protocols may include, but are not limited to, Advanced Mobile Phone Service (AMPS), ANSI-136, Global Standard for Mobile (GSM) communication, General Packet Radio Service (GPRS), enhanced data rates for GSM evolution (EDGE), code division multiple access (CDMA), wideband-CDMA, CDMA2000, and/or Universal Mobile Telecommunications System (UMTS). Other communication protocols may include, but are not limited to, Bluetooth®, REID and/or WLAN (e.g., 802.11a, 802.11b, 802.11e, 802.11g, 802.11i and/or 802.11n). Accordingly, the mobile terminal 100 may be configured to support cellular communication protocols as well as short distance communication protocols, such as Bluetooth®, RFID and/or WLAN. The memory 130 may represent a hierarchy of memory that may include volatile and/or non-volatile memory, such as removable flash, magnetic, and/or optical rewritable non-volatile memory. The processor 140 is coupled to the transceiver 125, the memory 130, the GPS unit 136, the speaker 138, and the user interface 155. The processor 140 may be, for example, a commercially available or custom microprocessor that is configured to coordinate and manage operations of the transceiver 125, the memory 130, the GPS unit 136, the speaker 138, and/or the user interface 155.

As noted above, the mobile terminal 100 may further include a user interface 155 coupled to the processor 140. The user interface 155 may include a microphone 120, a display 110 (such as a liquid crystal display), a joystick 170, a keyboard/keypad 105, a touch sensitive display 160, a dial 175, a directional key(s) 180, and/or a pointing device 185 (such as a mouse, trackball, touch pad, etc.). For example, the keyboard/keypad 105 may be operable to define alphanumeric characters/symbols on the display 110. However, depending on functionalities offered by the mobile terminal 100, additional and/or fewer elements of the user interface 155 may actually be provided. For instance, the touch sensitive display 160 may functionally replace a display 110, a keypad 105, and/or a pointing device 185. The touch sensitive display 160 may display a plurality of virtual command and/or control buttons. The command/control buttons may be selected by touching a stylus on the touch sensitive display 160 at the appropriate location(s) of the virtual buttons shown on the touch sensitive display 160, for example, to select and/or launch an application via a displayed menu screen. The foregoing components of the mobile terminal 100 may be included in many conventional mobile terminals and their functionality is generally known to those skilled in the art. Moreover, the processor 140 and the memory 130 are configured in accordance with at least one embodiment described herein.

In some embodiments, when a triggering event is received by the mobile terminal 100 from the external device 190 (FIGS. 2-3), the mobile terminal 100 determines the current location of the mobile terminal 100 using the GPS unit 136, e.g., to estimate the location of the vehicle as described herein. The user of the mobile terminal 100 may request directions to the location of the vehicle using the GPS unit 136 and a new current location. Although the mobile terminal 100 is illustrated as including a GPS unit 136, it should be understood that GPS information may be obtained from other sources, e.g., from a GPS unit on another external device such as the external device 190 or a GPS unit on the vehicle 192.

In some embodiments, the accelerometer 132 can be used to detect acceleration patterns indicating that either the mobile phone 100 has stopped traveling in a car, e.g., based on an acceleration pattern indicating that the phone 100 is being carried by a user who is walking or has stopped traveling in a vehicle above a threshold speed for longer than a threshold period of time.

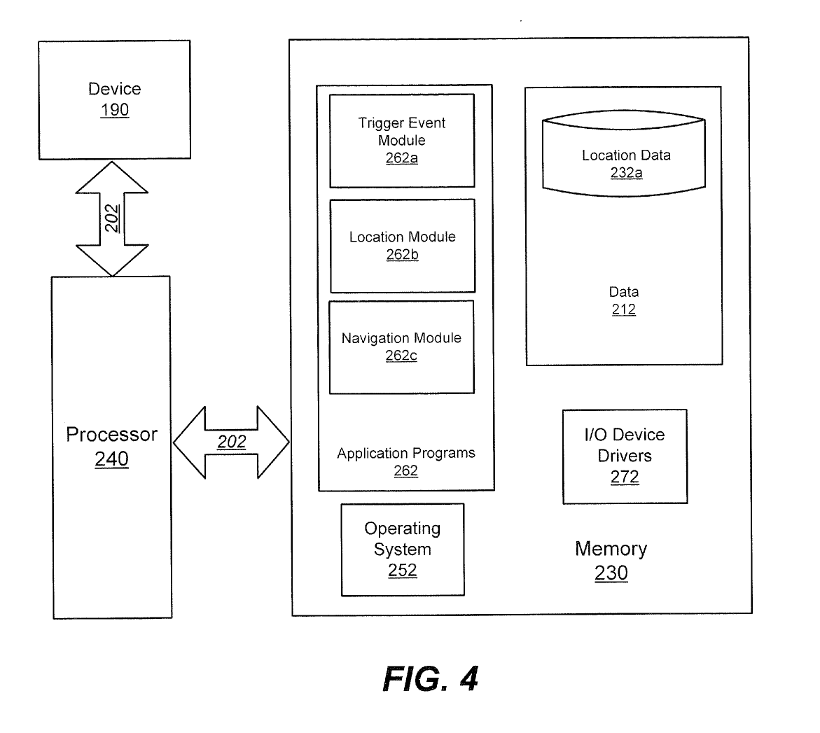

FIG. 4 illustrates a hardware/software architecture including a memory device 230 and a processor 240 that may be used to provide navigation-assisted location information responsive to a triggering event in a mobile terminal according to some embodiments of the present invention, such as the mobile terminal 100 of FIG. 2. In some embodiments, the processor 240 and memory 230 may respectively correspond to the processor 140 and memory 130 of the mobile terminal 100 of FIG. 2.

As illustrated in FIG. 4, the processor 240 is configured to communicate with the memory 230 and the external device 190 via a data bus 202. The memory 230 may be configured to store several categories of software, such as an operating system 252, applications programs 262, and input/output (I/O) device drivers 272. The operating system 252 controls the management and/or operation of system resources and may coordinate execution of programs by the processor 240. The I/O device drivers 272 typically include software routines accessed through the operating system 252 by the application programs 262 to communicate with input/output devices, such as those included in the user interface 155 of FIG. 3, and/or other components of the memory 230. The memory 230 further includes data 212 for the application programs 262 including one or more database(s) 232a. The database(s) 232a may be associated with the application programs 262. The databases may include geographic location data, files, names, contacts, e-mails, text messages, and/or other data that may be stored in the memory 230 and accessed by the application programs 262. More particularly, the data 212 may include locations data 232a for storing a location of a vehicle responsive to a triggering event.

The application programs 262 are illustrative of programs that implement various features according to embodiments of the present invention, and may include at least one application which supports operations for determining a location of a vehicle responsive to a triggering event as described herein. For example, the applications programs 262 may include a trigger event module 262a, a location module 262b and/or a navigation module 262c. The trigger event module 262a may detect a triggering event from the external device 190, such as a disconnection event (e.g., a disconnection from a handsfree communication system) and/or a signal indicating that operations of the vehicle have likely ceased (such as a signal from a keyless remote or keyless remote starter). The location module 262b determines a location of the mobile terminal 100 and/or vehicle 192 responsive to detection of the triggering event, and the triggering event module 262a and/or the location module 262b may determine and/or record the location in the location data 232a. When the user wishes to locate the vehicle at a later time, the user may employ the navigation module 262c to provide directions to the vehicle 192, for example, using a global positioning system (GPS) that uses the user's new current location to provide directions to the previously recorded location of the vehicle.

The present invention may be embodied as methods, electronic devices, and/or computer program products. Some embodiments of the present invention were described above with reference to block diagrams and/or operational illustrations of methods and electronic devices. In this regard, each block may represent a module, segment, or portion of code, which comprises one or more executable instructions for implementing the specified logical function(s). It is to be understood that each block of the block diagrams and/or operational illustrations, and combinations of blocks in the block diagrams and/or operational illustrations can be embodied on analog circuitry and/or digital circuitry. These program instructions may be provided to a controller circuit, which may include one or more general purpose processors, special purpose processors, ASICs, and/or other programmable data processing apparatus, such that the instructions, which execute via the controller, create means for implementing the functions/acts specified in the block diagrams and/or operational block or blocks. In some alternate implementations, the functions/acts noted in the blocks may occur out of the order noted in the operational illustrations. For example, two blocks shown in succession may in fact be executed substantially concurrently or the blocks may sometimes be executed in the reverse order, depending upon the functionality/acts involved.

These computer program instructions may also be stored in a computer-usable or computer-readable memory that may direct a controller circuit to function in a particular manner, such that the instructions stored in the computer usable or computer-readable memory produce an article of manufacture including instructions that implement the function specified in the flowchart and/or block diagram block or blocks. The computer-usable or computer-readable medium may be, for example but not limited to, an electronic, magnetic, optical, electromagnetic, or semiconductor system, apparatus, or device. More specific examples (a nonexhaustive list) of the computer-readable medium include the following: hard disk devices, optical storage devices, magnetic storage devices, random access memory (RAM) devices, read-only memory (ROM) devices, erasable programmable read-only memory (EPROM or Flash memory) devices, and compact disc read-only memory (CD-ROM).

The foregoing is illustrative of the present invention and is not to be construed as limiting thereof. Although a few exemplary embodiments of this invention have been described, those skilled in the art will readily appreciate that many modifications are possible in the exemplary embodiments without materially departing from the novel teachings and advantages of this invention. Accordingly, all such modifications are intended to be included within the scope of this invention as defined in the claims. Therefore, it is to be understood that the foregoing is illustrative of the present invention and is not to be construed as limited to the specific embodiments disclosed, and that modifications to the disclosed embodiments, as well as other embodiments, are intended to be included within the scope of the appended claims. The invention is defined by the following claims, with equivalents of the claims to be included therein.

That which is claimed is:

1. A method for locating a position of a vehicle on a mobile terminal, the method comprising:
identifying a triggering event associated with a communication link between the mobile terminal and an external device;
determining a geographic location that approximates the position of the vehicle responsive to the triggering event; and
subsequently displaying on the mobile terminal information regarding the geographic location that approximates the position of the vehicle.

2. The method of claim 1, wherein the external device comprises a handsfree communication system, and the triggering event comprises determining that a disconnection from the handsfree communication system has occurred.

3. The method of claim 2, wherein the disconnection from the handsfree communication link comprises a disconnection from a short radio wave handsfree communication link.

4. The method of claim 2, wherein the handsfree communication system is mounted on the vehicle.

5. The method of claim 1, wherein the external device comprises a handsfree communication system having a wired connection to the mobile terminal, and the triggering event comprises a disconnection from a wired connection between the mobile terminal and the handsfree communication system.

6. The method of claim 1, wherein determining the geographic location of the vehicle comprises receiving location information from a global positioning unit connected to the vehicle.

7. The method of claim 1, wherein the triggering event comprises detecting a communication from a remote keyless device that is configured to operate a component of the vehicle.

8. The method of claim 7, wherein the remote keyless device is configured to communicate the triggering event to the mobile terminal when the remote keyless device locks the vehicle and/or terminates an operation of the vehicle.

9. The method of claim 1, further comprising determining the geographic location responsive to detecting that the mobile terminal has ceased traveling above a threshold velocity for at least a threshold time, wherein the velocity is determined responsive to global positioning system signals.

10. The method of claim 1, wherein the mobile terminal comprises an accelerometer, and further comprising determining the location of the vehicle responsive to detecting a repetitive acceleration pattern that indicates that the mobile terminal has transitioned from a vehicle to a person who is walking.

11. A mobile terminal for locating a position of a vehicle, the mobile terminal comprising:
a triggering event module configured to associated with a communication link between the mobile terminal and an external device and to determine a geographic location that approximates the position of the vehicle responsive to the triggering event; and
a navigation module configured to subsequently display on the mobile terminal information regarding the geographic location that approximates the position of the vehicle.

12. The mobile terminal of claim 11, wherein the external device comprises a handsfree communication system, and the triggering event comprises determining that a disconnection from the handsfree communication system.

13. The mobile terminal of claim 12, wherein the disconnection from the handsfree communication link comprises a disconnection from a short radio wave handsfree communication link.

14. The mobile terminal of claim 12, wherein the handsfree communication system is mounted on the vehicle.

15. The mobile terminal of claim 11, wherein the external device comprises a handsfree communication system having a wired connection to the mobile terminal, and the triggering event comprises a disconnection from a wired connection between the mobile terminal and the handsfree communication system.

16. The mobile terminal of claim 11, further comprising a location module configured to determine location information from a global positioning unit.

17. The mobile terminal of claim 11, wherein the triggering event comprises detecting a communication from a remote keyless device that is configured to operate a component of the vehicle.

18. The mobile terminal of claim 17, wherein the remote keyless device is configured to communicate the triggering event to the mobile terminal when the remote keyless device locks the vehicle and/or terminates operations of the vehicle.

19. The mobile terminal of claim 11, wherein the triggering event module is configured to determine the geographic location responsive to detecting that the mobile terminal has ceased traveling above a threshold velocity for at least a threshold time, wherein the velocity is determined responsive to global positioning system signals.

20. The mobile terminal of claim 11, further comprising an accelerometer, wherein the triggering event module is configured to determine the location of the vehicle responsive to detecting a repetitive acceleration pattern that indicates that the mobile terminal has transitioned from a vehicle to a person who is walking.
